(19) United States
(12) Patent Application Publication
(10) Pub. No.: US 2013/0182730 A1
(43) Pub. Date: Jul. 18, 2013

(54) SLOT WAVEGUIDE STRUCTURE FOR WAVELENGTH TUNABLE LASER

(71) Applicants: Wenjun Fan, Milpitas, CA (US); Ruolln Li, Milpitas, CA (US)

(72) Inventors: Wenjun Fan, Milpitas, CA (US); Ruolln Li, Milpitas, CA (US)

(73) Assignee: Mars Technology

(21) Appl. No.: 13/349,523

(22) Filed: Jan. 12, 2012

(51) Int. Cl. H01S 3/10

(52) U.S. Cl. 372/20

(57) ABSTRACT

Exemplary embodiments provide a wavelength tunable laser device and methods using the wavelength tunable laser device for a laser tuning. An exemplary wavelength tunable laser device can include an active gain element, a slot waveguide structure, and a wavelength tuning structure including heating elements disposed around the grating structure for a wavelength selection.

### FIELD OF THE USE

The present teachings relate generally to laser devices and, more particularly, to wavelength tunable laser devices with slot waveguide.

### BACKGROUND

In recent years, there is considerable interest in silicon based photonics devices, along with progress of silicon processing for micro and nanometer-scale devices routinely fabricated with nanometer precision in high volume. However, for active photonic device, compound semiconductor based devices are more efficient as compared with silicon based devices. It is therefore desirable to provide a hybrid approach, combining technologies based on compound semiconductor and silicon, to form active photonic devices, e.g., to form wavelength tunable laser devices that can be operated at selectively variable frequencies to cover a wide wavelength range.

### SUMMARY

According to various embodiments, the present teachings include a laser device. The laser device can include an active gain element, a slot waveguide structure optically coupled with the gain element, and a wavelength tuning structure disposed over the slot waveguide structure. The slot waveguide structure can include a cladding layer covering a slot region formed by and between a pair of strips. The wavelength tuning structure can include a grating structure and a plurality of heating elements disposed around the grating structure.

According to various embodiments, the present teachings also include a method for laser tuning. In this method, a spectrum of light from an active gain element can be passed into a slot waveguide structure and can reflect between an end mirror of the active gain element and a grating structure that is configured over the slot waveguide structure. By locally adjusting a temperature of the grating structure, a refractive index of the grating structure can be adjusted. Accordingly, a reflection peak wavelength of the grating structure can be selected from the reflected spectrum of light by controlling the temperature.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate several embodiments of the present teachings and together with the description, serve to explain the principles of the invention.

FIG. 1A depicts a top view of an exemplary laser device in accordance with various embodiments of the present teachings.

FIG. 1B depicts a cross sectional view of the exemplary laser device in FIG. 1A in accordance with various embodiments of the present teachings.

### DESCRIPTION OF THE EMBODIMENTS

Reference will now be made in detail to exemplary embodiments of the present teachings, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

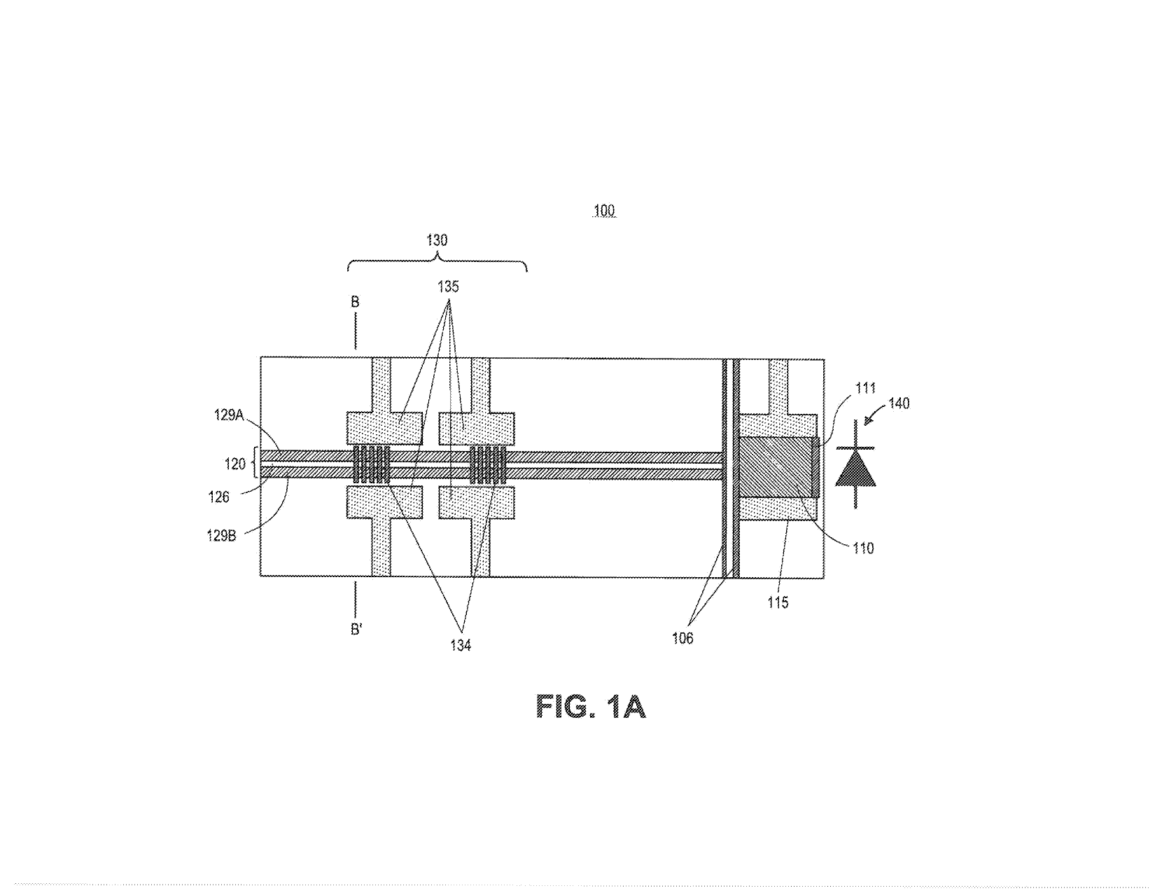

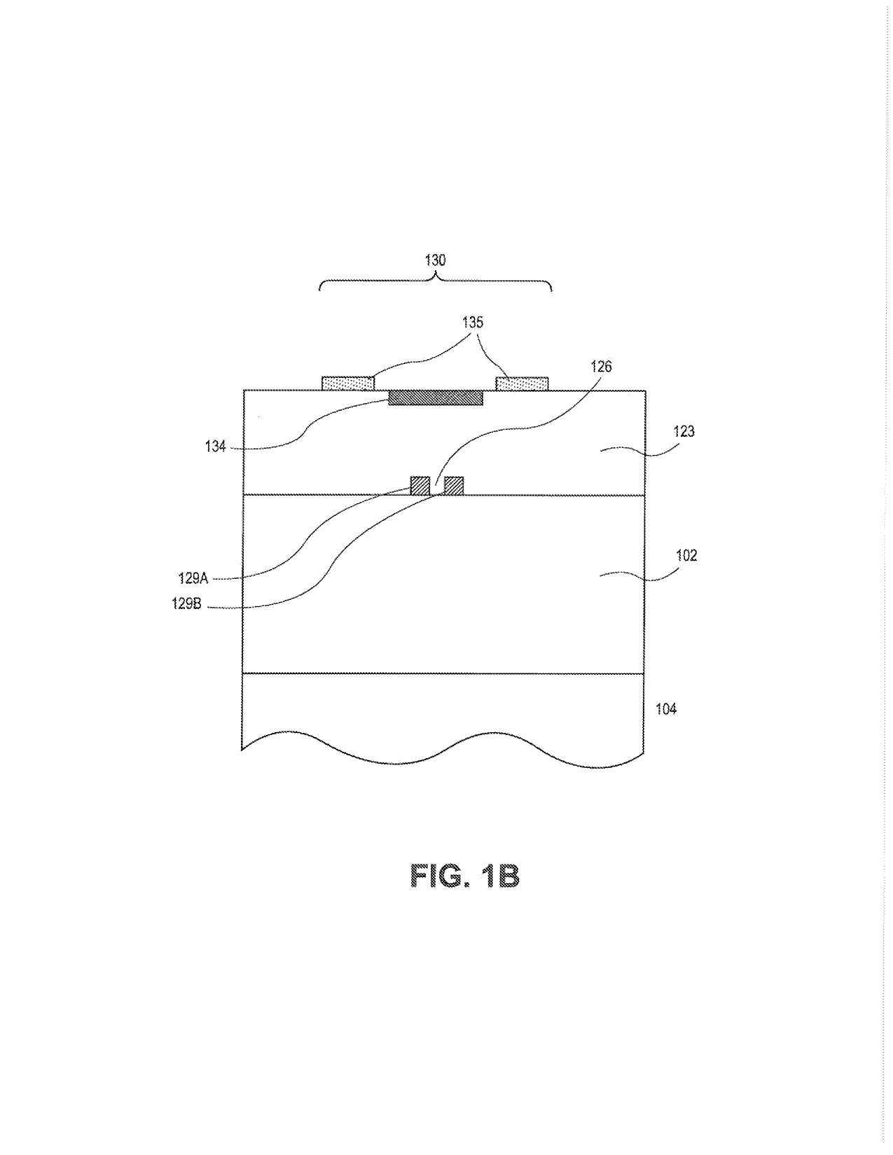

FIGS. 1A-1B depict an exemplary laser device 100 in accordance with various embodiments of the present teachings. Specifically, FIG. 1A depicts a top view of the device 100, while FIG. 1B depicts a cross sectional view in B-B′ direction of the laser device 100 in FIG. 1A. In one embodiment, the laser device 100 can include an external cavity tunable laser structure, wherein the light beam guiding and wavelength selection of the tunable laser structure can be based on a slot waveguide structure.

As shown in FIG. 1A, the laser device 100 can include an active gain element 110, a slot waveguide structure 120, a wavelength tuning structure 130, and an optical monitor device 140. As shown in FIG. 1B, the slot waveguide structure 120 can include an insulator layer 102, having strips 129a-b and a slot region 126 formed there-over. The slot waveguide structure 120 can further include a cladding layer 123 formed to cover the strips 129a-b and the slot region 126.

For example, the slot waveguide structure including a low-index optical waveguide can be fabricated from a semiconductor-on-insulator or silicon-on-insulator (SOI) substrate. The SOI substrate can include an insulator layer 102 overlying a substrate layer 104. A semiconductor layer or a silicon layer on the SOI substrate can form one or both strips of 129a and 129b of the slot waveguide structure 120. The SOI substrate can include a silicon (Si) substrate layer 104 with a silicon dioxide (SiO₂) insulator layer 102 and a semiconductor top (e.g., Si) layer including strips 129a and 129b. In various embodiments, additional elements of laser device 100 can be formed or fabricated in or from the semiconductor materials on the insulator layer 102. The insulator layer 102 can have a thickness ranging from about 200 nm to about 4 μm without limitation.

While described herein with reference to an exemplary embodiment employing an SOI substrate including a substrate layer 104, insulator layer 102, and semiconductor top layer including strip(s) 129a and 129b, the device 100 can be readily fabricated using a variety of other substrates. For example, the SOI substrate can omit the substrate layer and include only an insulator and a semiconductor layer on top of the insulator (e.g., silicon on sapphire). In such an SOI substrate, the insulator layer can essentially extend through an entire thickness of the substrate except for the semiconductor top layer. In another example, the insulator layer can be formed of a non-oxide material but another insulating material. In yet another example, the substrate does not include an insulator layer at all (e.g., a semiconductor substrate).

The slot waveguide structure 120 can include a slot or slot region 126 formed by and between the pair of strips 129a-b, which are spaced apart from one another. The slot region 126 can be essentially a guide region of the slot waveguide structure 120 where an optical field is confined.

The strips 129a-b can be formed of a semiconductor material such as silicon (Si) as described above, e.g., formed on an exemplary SOI wafer. In embodiments, the strips 129 a-b formed of Si can take the form of one or more of single crystalline Si, polycrystalline Si (polysilicon or poly-Si), and amorphous silicon (a-Si). In another example, the strips 129a-b can be formed of a material including, germanium (Ge), gallium arsenide (GaAs), gallium aluminum arsenide (GaAIAs), indium phosphide (InP), or a combination thereof.

In embodiments, various doping materials can be used for the strips 129a-b. For example, the strips 129 a-b can, be a doped silicon (Si), such as, for example, a germanium (Ge) doped silicon (Si). Moreover, the doping material of the first strip 129a can differ from the doping material of the second strip 129b. In embodiments, the first strip 129a can include a p-doped crystalline silicon while the second strip 129b can include an n-doped silicon.

The strips 129a-b can be formed of a semiconductor material having a relatively high refractive index compared to a refractive index of a material of the slot region 126. For example, the slot region 126 can include (e.g., be essentially filled with) an insulating, relatively lower refractive index, dielectric material such as, an optically transmissive oxide (e.g., SiO₂). The oxide can be grown or otherwise deposited in the slot region 126. Additionally, the strips 129a-b and the slot region 126 of the slot waveguide structure 120 can be covered by a cladding layer 123, as shown in FIG. 1B.

In embodiments, the slot region 126 and the cladding layer 123 can employ the same material or different materials. The slot region 126 and/or the cladding layer 123 can include linear or non-linear optical materials. For example, materials used for the slot region 126 and/or the cladding layer 123 can include, but are not limited to, silicon oxide, silicon nitride, polymers including, benzocyclobutene (BCB) -based polymer, polyimide, etc., and/or other organic materials including, (2[4-(dimethylamino)phenyl]-3-f[4-(dimethylamino)phenyl]ethynylgbuta-1,3-diene-1,1,4, 4-tetracarbonitrile) (DDMEBT), etc. In one embodiment, the slot region 126 and/or the cladding layer 123 can include materials (e.g., silicon oxide) doped with various rare-earth ions to provide light amplification. The rare-earth dopants can include, but are not limited to, Erbium, Ytterbium, Neodymium, and/or Holmium.

In an exemplary embodiment, the slot waveguide structure 120 can include a silicon slotted waveguide that is surrounded by a non-linear organic cladding, wherein the slotted geometry can be chosen to create an optical mode that is guided by the silicon, but that has maximum optical intensity inside the organic material. In embodiments, such slot waveguide can be fabricated by first producing the SOI slot waveguide using standard semiconductor manufacturing processes and then covering the SOI slot waveguide with an organic layer. The organic layer, e.g., a layer of DDMEBT, can be formed by, e.g., molecular beam deposition.

In embodiments, the slot region 126 can separate the strips 129a-b, for example, having a width ranging from about tens of nm to about hundreds of nm such as from about 10 nm to about 1000 nm, and a height ranging from about tens of nm to about hundreds of nm such as from about 10 nm to about 1000 nm, although the dimensions of the slot region 126 are not limited. In embodiments, a particular width of the slot 126 can depend, at least in part, on the relative refractive indices of the strips 129a-b and the slot region 126.

As shown in FIG. 1B, the wavelength tuning structure 130 can be formed on the cladding layer 123. The wavelength tuning structure 130 can include, for example, a grating structure 134 having a plurality of gratings, and heating elements 135, which can be formed around the grating structure to provide wavelength swept filtering and feedback. The wavelength tuning structure 130 including the grating structure 134 and the heating elements 135 can adjust the reflective index of the surrounding material, which in turn can adjust the spectrum response of the grating structure 134. Generally, the heating elements 135 can be provided to locally change (e.g., increase) the temperature of the surrounding material, e.g., the grating structure 134 and/or the slot waveguide structure 120. As a result, a refractive index of the grating structure 134 can be changed through a thermal-optical effect by the local heating. Accordingly, a reflection peak wavelength of the grating structure 134 can be selected, by controlling the temperature of the heating elements 135. The wavelength of the emitted laser beam can then be controlled to be a desirable value by controlling the refractive index of grating structure 134 and/or the slot waveguide structure 120.

In embodiments, the grating structure 134 can include a plurality of reflection gratings including, but not limited to, a single grating, a sample grating, a supper structure grating, and/or their combined grating structures. In embodiments, the grating structure 134 can be fabricated from a material including, but not limited to, silicon oxide, silicon nitride, a polymer including benzocyclobutene (BCB) -based polymer or polyimide, an organic material including (2-[4-(dimethylamino)phenyl]-3-f[4-(dimethylamino)phenyl]ethynylgbuta-1,3-diene-1,1,4, 4-tetracarbonitrile) (DDMEBT), or combinations thereof. As disclosed herein, the slot region, the cladding layer, and the grating structure can be formed using the same or different materials. In one embodiment, the grating structure 134 can be current tuned by the surrounding heating elements 135.

In embodiments, the heating elements 135 can include planar metal electrical heaters. Alternatively, the heating elements 135 can be a common large heater, such as a TEC (i.e., thermal-electrical cooler). The heating elements 135 can have an operating temperature ranging from about −40° C. to about 300° C. or from about 20° C. to about 90° C., without limitation.

In embodiments, phase section can be configured in a portion of the slot waveguide structure 120 on the wavelength tuning structure 130 and/or in the active gain element 110. The phase section can be composed of similar heating elements as the elements 135 around the portion of the slot waveguide structure 120 on the tuning structure 130. In one embodiment, the heating elements 135 can be configured to heat the grating structure 134 and/or the slot waveguide structure 120. By adding current on the heater, the surrounding temperature change can cause the surrounding material index change, which in turn changes the effective length of the slot waveguide structure 120, acting as the phase changing. Alternatively, as for the phase section process on active gain element 110, by adjusting the injection current, the material index changes, which in turn changes the effective length of the slot waveguide structure 120, acting as the phase changing.

Referring back to FIG. 1A, the laser device 100 can include an active gain element 110 for creating spontaneous emission of broadband photons. The active gain element 110 can have an end mirror 111 and can be coupled or aligned with the slot waveguide structure 120 on an opposing end of the active gain element 110. Both the active gain element 110 and the slot waveguide structure 120 can have an alignment facet covered with an antireflective (AR) coating 106.

The active gain element 110 can be, e.g., a light emitting semiconductor device, a laser diode, an optical amplifier, etc. The active gain element 110 can be a multi-chip assembly. One of ordinary skill in the art will understand that there are a number of gain elements known in the art that may be used.

In one embodiment, the active gain element 110 can be flip-chip bonded or otherwise bonded to the slot waveguide structure 120 that is, for example, formed on a SOI wafer. The active gain element 110 can include a metal pad region 115 to provide bottom electrical contact for the gain media or to serve as a metal pad for the exemplary flip-chip bonding of the element 110 to the structure 120. In embodiments, V-groove structures can be formed on the exemplary SOI wafer for a self-alignment of, e.g., optical fiber for passing a spectrum of light out of the emitting facet of the slot waveguide structure 120. In embodiments, control microelectronics components, such as, for example, electrodes, current drivers, TEC control circuits, etc., can be built on the same SOI wafer.

The active gain element 110, e.g., light emitting semiconductor devices, can produce a range of wavelengths. The light beam from the active gain element 110 can be provided to the slot waveguide structure 120 and can reflect between the end mirror 111 of the active gain element 110 and the grating structure 134 at the opposing end of the slot waveguide 120 to create an emitted beam of laser light. The wavelength of the emitted laser beam can be selected by adjusting the reflective index of the material surrounding the grating structure 134 with the heating elements 135. In embodiments, the laser device 100 can include a resonant cavity, either all of the resonant cavity or a portion of the resonant cavity including the slot waveguide 120.

The laser beam emitted from the device 100 can be monitored by the optical monitor device 140 as shown in FIG. 1A. The optical monitor device 140 can be an optical power-monitor diode to monitor power and wavelength of the emitted laser beam. The optical monitor device 140 can be configured at the beam emitting path from the active gain element 110, e.g., at the end mirror 111 of the active gain element 110, to select the laser wavelength and the monitor the laser power of the emitted laser beam.

As a result, the laser device 100 can have a tuning range of at least a few tens of nanometer, for example, having an overall tuning range of about 40 nm. Such tuning range can be continuous having a wavelength ranging from about 1530 nm to about 1565 nm, or from about 1585 nm to about 1625 nm. The emitted laser beam can have an output power of at least about 5 mW or ranging from about 5 mW to about 40 mW.

In this manner, a wide wavelength tunable laser device can be provided without using moving parts and without using complicated compound semiconductor material. The wide wavelength tunable laser device can be manufactured by known high-volume microelectronics techniques without adding manufacturing cost. Further, the exemplary SOI platform can be configured for self-aligned assembly and control electronics components.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. The term “at least one of” is used to mean one or more of the listed items can be selected.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume values as defined earlier plus negative values, e.g. −1, −1.2, −1.89, −2, −2.5, −3, −10, −20, −30, etc.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

1. A laser device comprising:
an active gain element;
a slot waveguide structure optically coupled with the active gain element, wherein the slot waveguide structure comprises a cladding layer covering a slot region formed by and between a pair of strips; and
a wavelength tuning structure disposed over the cladding layer of the slot waveguide structure, wherein the wavelength tuning structure comprises a gating structure and a plurality of heating elements disposed around the grating structure.

2. The device of claim 1, wherein the pair of strips is formed of a material selected from the group consisting of silicon (Si), germanium (Ge), gallium arsenide (GaAs), gallium aluminum arsenide (GaAlAs), indium phosphide (InP), and a combination thereof.

3. The device of claim 1, further comprising an optical monitor device coupled to one end of the active gain element for monitoring wavelength selection and a power of an emitted laser beam.

4. The device of claim 1, wherein each of the slot region, the cladding layer, and the grating structure is formed of a material selected from the group consisting of silicon oxide, silicon nitride, a polymer comprising benzocyclobutene (BCB) -based polymer or polyimide, an organic material comprising (2-[4-(dimethylamino)phenyl]-3-f[4- (dimethylamino)phenyl]ethynylgbuta-1,3-diene-1,1,4,4-tetracarbonitrile) (DDMEBT), or combinations thereof.

5. The device of claim 1, wherein one or more of the slot region and the cladding layer are formed of a material doped with rare-earth dopants selected from the group consisting of Erbium, Ytterbium, Neodymium, Holmium, and combinations thereof.

6. The device of claim 1, wherein one or more of the pair of the strips are a portion of a semiconductor layer of a semiconductor-on-insulator substrate, the semiconductor layer overlaying an insulator layer of the semiconductor-on-insulator substrate.

7. The device of claim 1, wherein a width or a height of the slot region ranges from about 10 nm to about 1000 nm.

8. The device of claim 1, wherein the active gain element comprises an end mirror on a first facet and an anti-reflection (AR) coating on a second facet that is coupled with the slot waveguide structure.

9. The device of claim 1, wherein the grating structure comprises a single grating, a sample grating, a supper structure grating, or their combined grating structures.

10. The device of claim 1, wherein the plurality of heating elements comprises a pair of planar metal electrical heaters.

11. A method for laser tuning comprising:
passing a spectrum of light from an active gain element into a slot waveguide structure, wherein the spectrum of t reflects between an end mirror of the active gain element and a grating structure configured over the slot waveguide structure;
locally adjusting a temperature of the grating structure to adjust a refractive index of the grating structure; and
selecting a reflection peak wavelength from the reflected spectrum of light by controlling the temperature of the grating structure;
wherein the slot waveguide structure comprises a cladding layer covering a slot region formed and between a pair of strips.

12. The method of claim 11, wherein the pair of strips is formed of a material comprising silicon (Si), germanium (Ge), gallium arsenide (GaAs), gallium aluminum arsenide (GaAlAs), indium phosphide (InP), or a combination thereof.

13. The method of claim 11, further comprising monitoring a wavelength and a power of an emitted laser beam comprising the selected reflection peak wavelength.

14. The method of claim 13, wherein the emitted laser beam has a tunable wavelength ranging from about 1530 nm to about 1565 nm and a tunable power ranging from about 5 mW to about 40 mW.

15. The method of claim 11, further comprising a phase section process by locally adjusting a temperature of the slot waveguide structure.

16. The method of claim 11, further comprising a phase section process on the active gain element.

17. The method of claim 11, wherein each of the slot region, the cladding layer, and the grating structure is formed of a material selected from the group consisting of silicon oxide, silicon nitride, a polymer comprising benzocyclobutene (BCB)-based polymer or polyimide, an organic material comprising (2-[4-(dimethylamino)phenyl]-3-f[4- (dimethylamino)phenyl]ethynylgbuta-1,3-diene-1,1,4,4-tetracarbonitrile) (DDMEBT), or combinations thereof.

18. The method of claim 11, wherein one or more of the slot region and the cladding layer are formed of a material doped with rare-earth dopants selected from the group consisting of Erbium, Ytterbium, Neodymium, Holmium, and combinations thereof.

19. The method of claim 11, wherein the pair of the strips are formed from a semiconductor layer overlaying an insulator layer of a semiconductor-on-insulator substrate.

20. The method of claim 11, wherein the active gain element is flip-chip bonded to the slot waveguide structure.
